(19) United States
(12) Patent Application Publication
(10) Pub. No.: US 2013/0117378 A1
(43) Pub. Date: May 9, 2013

(54) Method for collaborative social shopping engagement

(71) Applicants: Radoslav P. Kotorov, Somerset, NJ (US); Yoshiko Akai, New York, NY (US)

(72) Inventors: Radoslav P. Kotorov, Somerset, NJ (US); Yoshiko Akai, New York, NY (US)

(21) Appl. No.: 13/668,297

(22) Filed: Nov. 4, 2012

Related U.S. Application Data
(60) Provisional application No. 61/556,258, filed on Nov. 6, 2011.

(51) Int. Cl. G06F 15/16

(52) U.S. Cl. 709/205

(57) ABSTRACT

A method and system for soliciting shopping advice from social media friends by capturing and posting pictures or questions about desired consumer items to all or a select group of friends belonging to one or more social networks or who subscribe to particular applications. The method provides means to capture, aggregate, and notify in real-time the user soliciting advice about incoming responses. The responses may be submitted in structured form such as votes, as unstructured free text comments, or as pictures. The method and system also provides means to overlay the information with relevant targeted offers from third parties.

This application claims the benefit of a U.S. provisional application Ser. No. 61/556,258 filed Nov. 6, 2011, by Kotorov and Akai, now abandoned.

### FIELD OF THE INVENTION

This invention relates to the techniques for providing electronic real-time feedback to individual postings and inquiries, more particularly, in addition to the prior art, it provides means to make ad hoc inquires for decision support by automatically generating a feedback form from one or more snapped photos on a mobile device, by posting the feedback form across multiple social and communication networks, and by collecting and aggregating the feedback and voting result in real time to indicate the level of social support or lack of support for the inquiry.

### BACKGROUND OF THE INVENTION

Today, social networks are widely being used for sharing personal experiences, but are not at all used to support individual decision making.

Social networks have evolved as means to replicate the in-person social experiences in the virtual space of the World Wide Web. This is driven by ever increasing busy lifestyle and mobility of individuals, the spread of friends across different geographies, and by our innate desire to stay in touch with our friends, families, acquaintances, and relatives. Hence, individuals are spending more time engaging and interacting within their online social networks.

One of the key elements of socializing is the sharing of experiences. What a person does; where he or she travels; what he or she enjoys; what restaurants they visit; what they cook; what they read; what he or she has achieved; what surprised them; etc., are just a few types of experiences that users like to share in order to keep their friends and families informed about themselves. Their social friends can comment or express appreciation by clicking on a “Like” button. The “Like” button has become the digital equivalent of a smile, or a nod of approval, or the “thumbs-up” gesture.

Another no less important element of our in-person social interactions is the ability to seek and obtain advice from friends, peers, and relatives. Seeking advice from a group of individuals, as it frequently happens when people discuss their concerns and personal matters while having dinner, or coffee, or a glass of wine, is an entirely new area that has not yet been implemented within the digital social networks. The present social media networks do not provide means for individuals to seek collective decision support from their social friends in real time and in an ad hoc fashion. This is further complicated when friends are spread across different social networks.

Many questions typically arise in an ad hoc fashion when an individual is on the go, an opportunity presents itself, and he or she needs social support to make a decision. Do I buy this or that; do I go to this place or that; Is this better for me than that; etc., are just a few examples of decision-making questions that initiate social discussions to help the individual make a decision. Yet, they are hard to answer when one's decision support buddies are not there with him/her. Furthermore, unlike the shared experiences, decision-making questions require definite responses from all individuals who partake in the discussion. Thus, they are fundamentally different from the “Like” button, as they require participants to explicitly state which choice they support or do not support especially when two or more choices are given. Lastly, one's social network may consist of individuals who are spread across multiple social media and communication networks. Thus, the individual needs to be able to post his request across multiple networks at once and collect in real time tabulated feedback from all the networks. The new smart phones offer a unique opportunity for mobile users to capture images in ad hoc fashion and convert them instantly to decision-making questions that their social friends can answer from any device at any place in real time. The present invention provides the means to fulfill these needs.

### SUMMARY

In accordance with the embodiments described herein, a method and a system is disclosed for the creation of personal decision-making questions and solicitation of social decision support across multiple social and communication networks. This summary is not an extensive overview, and it is not intended to identify key critical elements or delineate the scope thereof. Its sole purpose is to present some concepts in a simplified form as a prelude to more detailed description that is presented later.

The method of the invention provides means for individuals to snap pictures via mobile devices, to automatically generate a single decision-making question form from one or more of the taken pictures, and to instantly distribute or post the single decision-making question form to any number of social media, email or text-massaging systems directly from the mobile device. The single decision-making question form contains input controls for collecting real-time feedback from other social network members, typically referred as friends. The user feedback can be provided in a form of votes or comments. The invention provides means to collect and aggregate the feedback from all systems and present updated results to the user in real time as they are being posted. The aggregated results for multi-item decision-making questions are displayed on a stacked single bar suitable for small form factor of mobile device screens. The stacked single bar is divided into segments proportionate to the support received for each choice. For binary choices, the stacked bar is split into two segments proportionate to each support result. For multiple choices, the bar is split into a single “Against” and as many “For” proportionate segments as there are choices. On mobile devices with small displays, images are typically stacked behind one another and the users navigate them using a swipe gesture. As users navigate stacked images, the corresponding segment of the support result is highlighted. Users can configure the default social networks, email, and text messaging systems to which their post will be distributed in a bulk upload fashion. Users can also control sharing options for the social networks, email, and text messaging systems for each individual post. The real time results can be augmented dynamically with commercial content, such as advertising, coupons, or purchase offers. The system algorithmically determines the relevance of each individual post to participating retailers and pushes notification to them so that they can overlay the original post with commercial content. Social network members can vote on the commercial content also, and retailers can modify it in real time based on the member input, thus, creating a bazaar-like bargaining interaction.

The present invention offers advantages and improvements over prior art because it allows for the ad hoc creation of personal decision-making questions on mobile and computer devices that can be posted and distributed across multiple social and communication networks for gathering collective advice and feedback. While there are many methods for sharing experiences and many ways to conduct surveys for research purposes, there are no means and technologies to create and share personal decision-making questions in an easy and intuitive way that mimics the way in which they typically occur when people browse shops together or discuss these decision-making problems in person. Such personal decision-making questions pop up spontaneously and are discussed instantly as they arise. The instant generation of a decision-making question form from snapped photos in the present invention allows mobile users to easily seek advice as the need arises without having to write multiple personal emails or making multiple personal calls. The availability of social media friends around the world at any given time means the support responses come in real time from around the world without the user waiting for response to each email or trying to find a friend who is available. The aggregation of collective feedback gives the user a single view of the opinions of his or her social friends. The innovative graphs allow for the display of complex aggregated results on a small form factor displays. The ability for retailers to append offers to the user postings and modify these offers based on social voting introduces a bazaar-like gaming aspect in the social interactions for decision support.

### BRIEF DESCRIPTION OF THE DRAWINGS

FIG. 1 shows a user posting an ad hoc, real-time decision-making question across multiple social and communication networks.

FIG. 2 is a high-level diagram of an embodiment of the system for providing ad hoc, real-time, social decision support across the user's multiple networks.

FIG. 3A illustrates the creation and posting of an ad hoc, real-time decision support request via a mobile device.

FIG. 3B illustrates the real-time social voting on an individual decision-making question from within one of the social networks.

FIG. 3C illustrates how to externalize the feedback and social voting from within a particular social network to a dedicated independent web page.

FIG. 3D shows a dedicated independent web page for social feedback and voting.

FIG. 3E shows a dedicated mobile application module for posting feedback and votes to decision-making questions.

FIG. 3F shows the feedback and the aggregated results of votes on other members' post within a native mobile application.

FIG. 4A shows the feedback and aggregated results of votes on the user's own posts.

FIG. 4B shows the commercial content that is appended to the user post.

FIG. 5A shows the aggregated feedback for a multi-item decision-making question post.

FIG. 5B illustrates how the display of the post changes as the user navigates between different items.

FIG. 6A illustrates a single stacked bar displaying the aggregated voting results on multi-item decision-making questions.

FIG. 6B illustrates how incoming votes and user navigation between the items change the state and display of a single stacked bar.

FIG. 7 illustrates the user subscription to channels for receiving push communications.

FIG. 8 illustrates the management of social media push campaigns by the channel members.

### DETAILED DESCRIPTION OF THE INVENTION

Various embodiments of the present invention will be described in detail with the reference to the drawings, where like reference numerals represent like parts and assemblies throughout the several views. References to various embodiments do not limit the scope of the invention, which is limited only by the scope of the claims attached hereto. Additionally, any examples set forth in this specification are not intended to be limiting and merely set forth some of the many possible embodiments for the claimed invention. Among other things, the present invention may be embodied as methods or devices. Accordingly, the present invention may take the form of an entirely hardware embodiment, or entirely software embodiment, or an embodiment combining software and hardware aspects. The following detailed description is, therefore, not to be taken in a limiting sense.

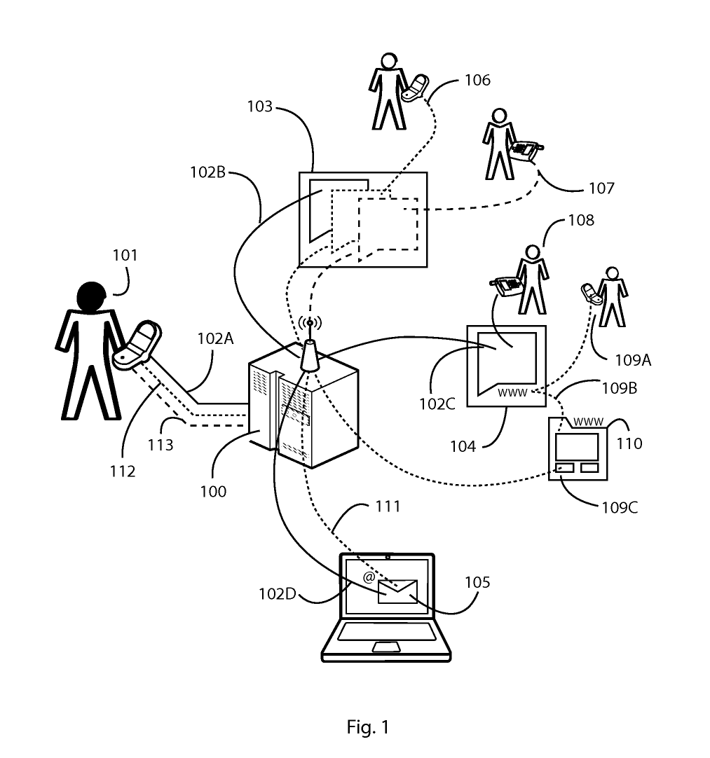

FIG. 1 is a high-level diagram showing a user 101 posting 102A a decision-making question via an application server component 100 to a social media network 103, a messaging system 104, and an email system 105. The distribution service re-routes the posting 102A to different networks to which the user 101 belongs, and which he or she has selected to make the posting 102A available to. 102B, 102C, and 102D indicate the different posting paths for the original post 102A. Users 106 and 107 provide feedback from within the social media network 103. Feedback 111 is posted to the application server component 100 from within an email system 105. User 108 is reading the post without providing any feedback. User 109A is being redirected 109B from within messaging system 104 to a dedicated web page 110 to provide feedback via the embedded interactive controls 109C.

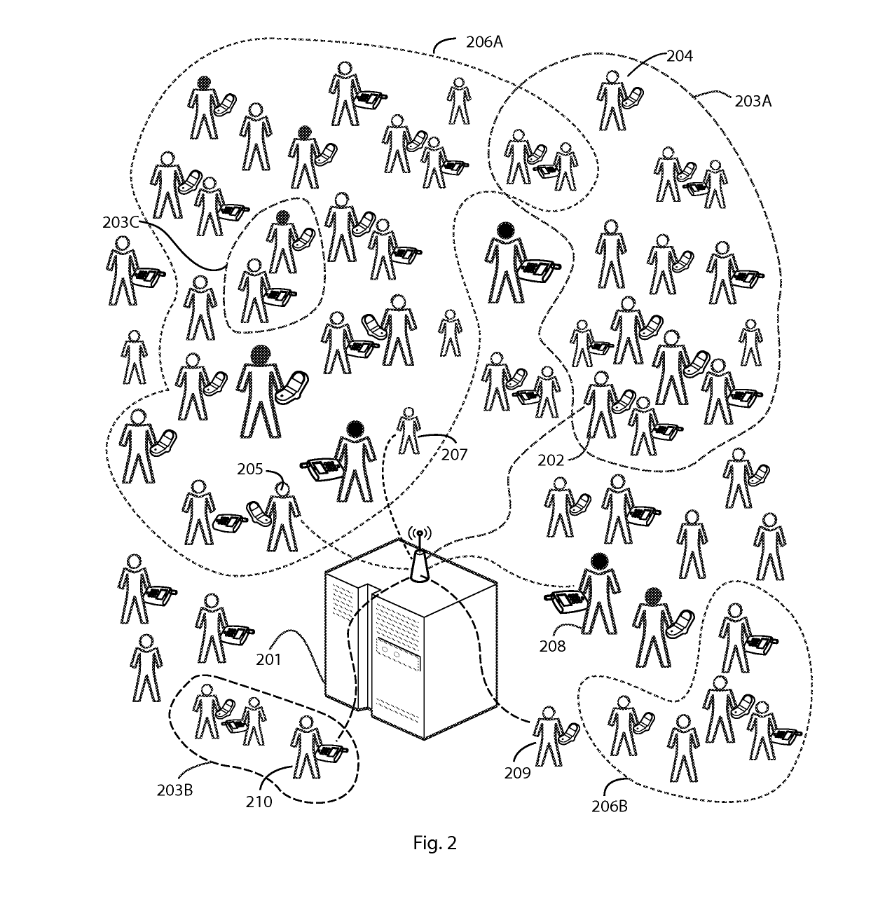

FIG. 2 is a high-level diagram showing multiple individuals posting and responding to social decision-making questions. User 205 has a geographically distributed network of social friends comprising of 206A and 206B. User 202 has his own geographically distributed network of social friends comprising of 203A, 203B, and 203C. Individuals can belong to more than one social network, for example, individuals in user 202's network 203C also belong to user 205's network 206A. The individuals in 203C are, thus, friends of both user 202 and user 205, and they can see and vote on posts from both of them. Users 202 and 205 have each posted their decision-making questions to their respective social networks via the application server component 201. Individual 207 is replying to the post of user 205. Individuals 204 and 210 are replying to the post of user 202. Users 202 and 205 may choose to make their posts public and allow individuals who do not belong to their private social networks to see their posts and provide feedback on their posts as do individuals 209 and 208.

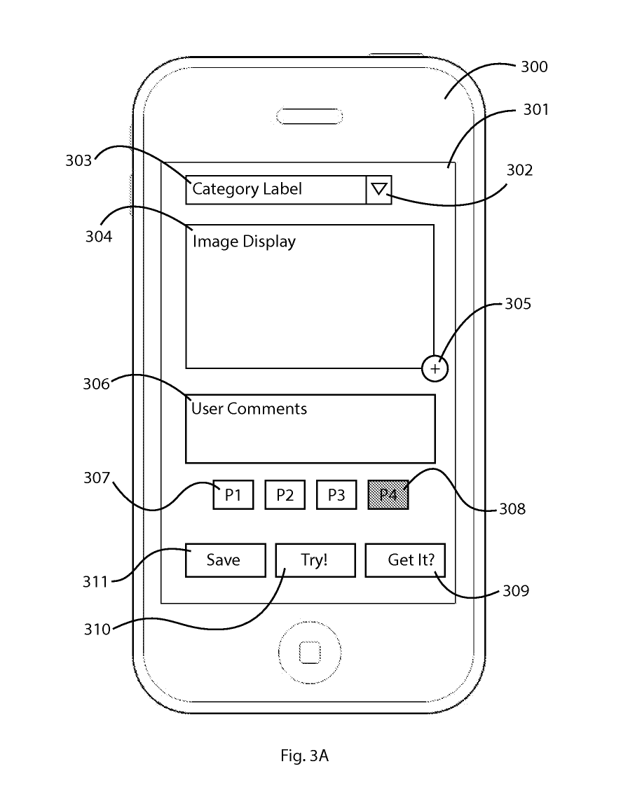

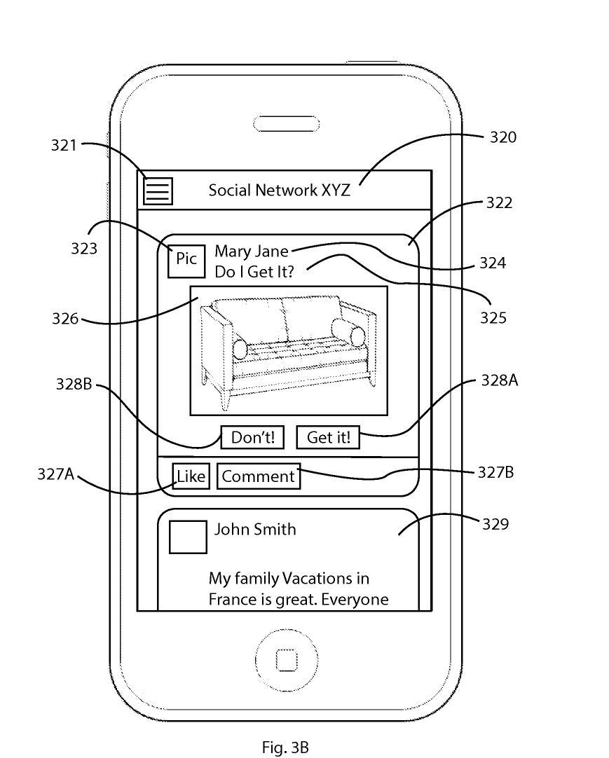

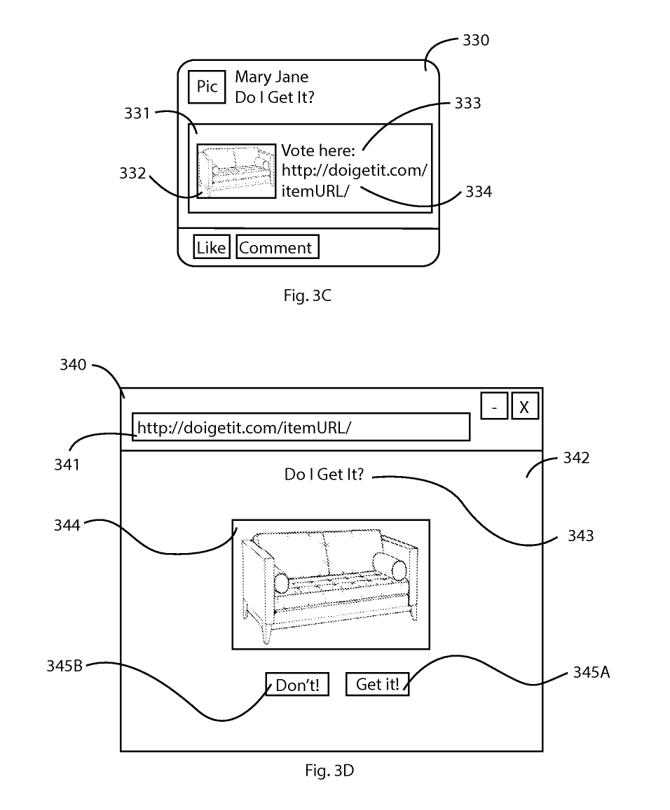

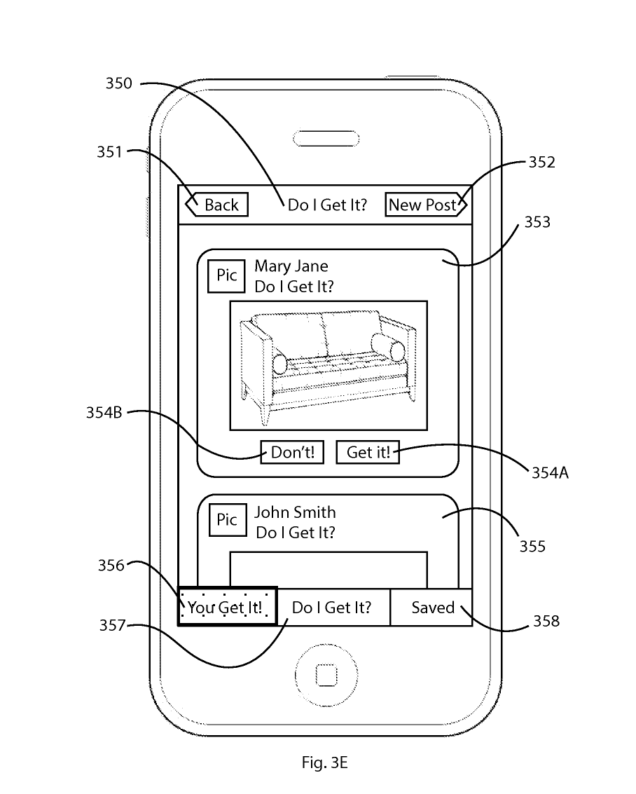

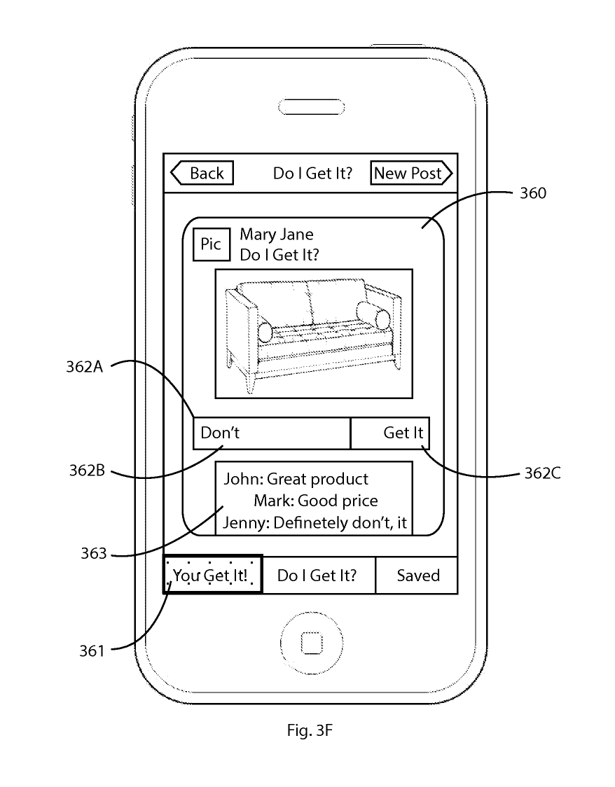

FIG. 3A shows the application module 301 for making decision-making question posts from a mobile device 300. 302 is a drop down box control allowing the user to select a category label 303 for the post. 304 is an image container that allows users to select, add, and display an image for the item referenced in the decision-making question. Tapping on the image container 304 prompts the user to snap a new image, to select an existing image from the photo album on the device, or to replace the current image. 305 is an action button that initializes a method to add additional images in order to generate a multiple choice decision-making question, such as “Do I get X, or Y, or Z, or none of them?” 306 is a free form text input control for the user comments. 307 is a social network selection toggle button that allows users to activate or deactivate particular social networks to share the current post. P1, P2, and P3 are set as the active networks to which the current decision-making question will be posted. 308 is a grayed out toggle button indicating that the post will not be distributed to the network P4. Action button 309 will post the decision-making question to networks P1, P2, and P3 simultaneously. Action button 310 will reframe the decision-making question as a user generated recommendation and post it to the networks P1, P2, and P3 simultaneously. Action button 311 will save the current decision-making question within the system for later posting. For those skillful in the art, it will become evident that the layout and the functionality of the application module 301 can vary.

FIG. 3B shows a social network application screen 320 with two posts 322 and 329. 321 is a standard menu button in social network applications to access the other options and application screens. Post 322 is an ad hoc decision-making question. Post 329 is a social networking standard experience sharing post. Post 322 contains the profile picture 323 and the screen name 324 of the individual making the post, a picture 326 of the item for which the member is soliciting advice, a call to action 325 that is automatically generated by the present method, and voting buttons 328A and 328B for the other users to provide their feedback. The post may be wrapped in a standard social network package which may contain additional elements, such as the “Like” button 327A and the “Comment” button 327B.

FIG. 3C shows a decision-making question post 330 with an alternative layout 331 to the post shown on FIG. 3B. The post layout 331 contains a picture 332 of the item for which the member is soliciting advice, a call to action 333 that is automatically generated by the present invention, and a URL 334 to an external Web page that contains input controls to provide the user feedback. The URL 334 is also automatically generated by the present invention and appended to the post. For those skillful in the art, it will become evident that the layout and the method to provide feedback via the internet can vary.

FIG. 3D shows a web page 342 displayed within a standard browser 340 and accessible via an individual unique URL 341 for each decision-making question created with the present invention. The Web page 342 is automatically generated when the post is created and contains a call to action label 343, a picture 344 of the item for which the member is soliciting advice, and voting controls 345A and 345B. The number of images displayed and the number of voting buttons vary based on the number of items within a single post. The button labels are automatically generated by the present invention based on the context of the user post, for example, the labels change when the post is a user recommendation. Additional input controls, such as text input box, can be embedded in the web page 342. The web page 342 is compatible with all mobile and computer devices.

FIG. 3E shows two posted decision-making questions 353 and 355 within the native application 350 of the present invention. 351 is a navigation button within the native application 350 that allows users to move to different application modules. 352 is an action button that initiates the application screen for creating and posting new decision-making questions. 356, 357, and 358 are another set of navigation buttons. Navigation button 356 is highlighted to indicate that the user is in the application screen for viewing and voting on other members' posts. Tapping on the navigation button 357 will take the user to view and edit his or her posts. Tapping on the navigation button 358 will take the user to his or her saved decision-making questions, which he or she can edit, post, or delete. Action buttons 354A and 354B allow the user to submit his or her votes for the post 353.

FIG. 3F shows the social feedback and aggregated results of votes for another member's post 360. Navigation button 361 is highlighted to indicate that the user is in the application screen for viewing and voting on other members' posts. 362A is a single stacked bar chart-like component to visualize the proportion of positive 362C and negative 362B votes. 363 is a text input component for displaying and adding user comments to a post.

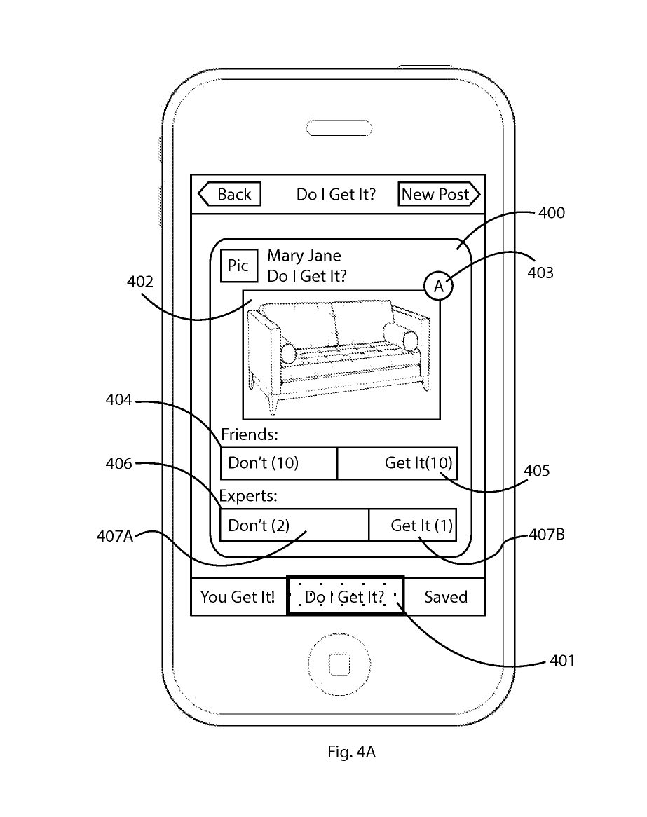

FIG. 4A shows the feedback and aggregated results of votes for the user's own post 400 as indicated by the highlighted navigation button 401. 402 is an image stacking component showing an image of the item for which the user has requested social advice. 403 is a real time indicator controller showing that the post is overlaid with commercial content that can be viewed by swiping or tapping on the image stacking component 402. 404 is a single stacked bar chart-like component to visualize the voting results submitted by one's social friends. 405 shows the proportion, the label and the vote counts for the positive votes. Both the proportion and the labels for the positive and negative votes are updated in real-time by the system. 406 is a single stacked bar chart-like component to visualize the voting results submitted by the designated experts on the subject to which the decision-making question pertains. Each decision-making question is algorithmically evaluated and assigned to a subject matter area, which is accessible by the experts to provide their feedbacks to. Decision-making questions can also be pushed to experts automatically for their feedback. Users have means to control which experts have access to their posts as it is shown later in this disclosure. 407A and 407B show the distribution of expert votes on post 400.

FIG. 4B shows the user post 400 on the application screen for viewing one's own posts as indicated by the highlighted navigation button 401. 420 is a real-time indicator controller signaling that commercial content has been added. 421 is the image stacking component displaying an appended commercial offer to the user post. 422A and 422B show the proportion of votes for or against the commercial offer displayed in the image stacking component 421. 423 shows the comments on the commercial offer displayed in the image stacking component 421.

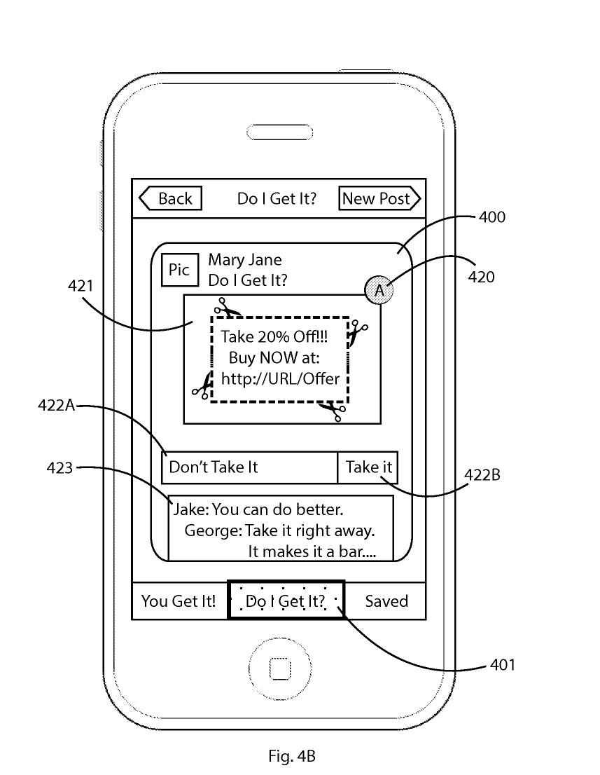

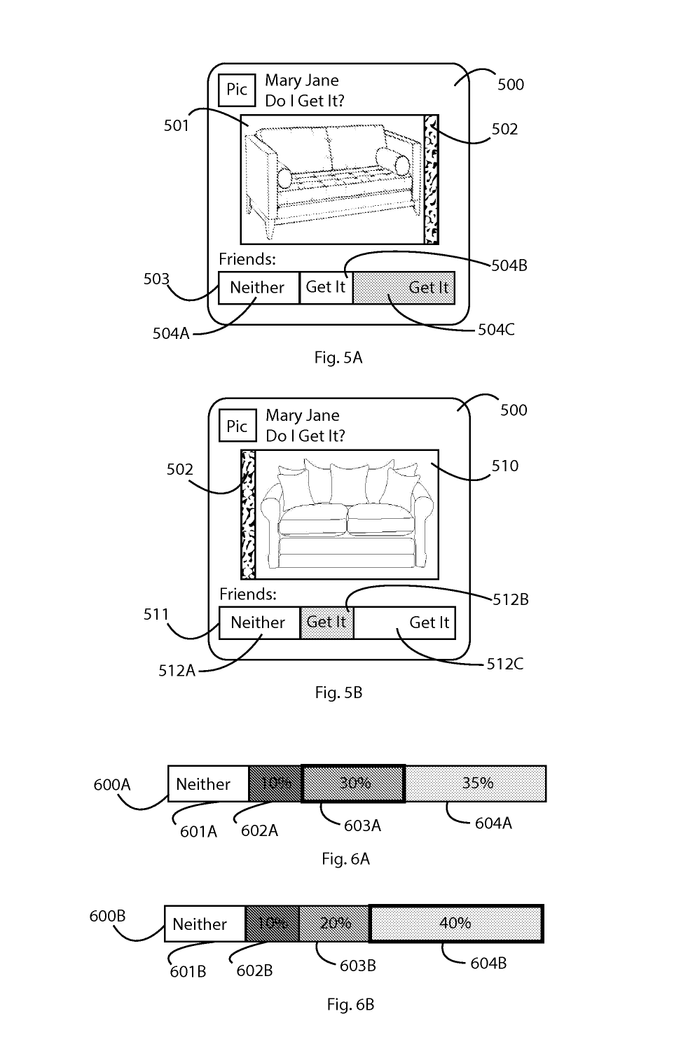

FIG. 5A shows an interactive display 500 for multi-item decision-making questions. 501 is a stacked image container for displaying an ordered sequence of multiple images. The stacked image container displays one image at a time. The side bar 502 within the said stacked image container 501 indicates that the user can change the displayed image by using a tap or a swipe gesture on mobile devices, or a mouse click on desktop computers. The side bar 502 can be displayed on the left, right, or both sides of the said stacked image container 501 to indicate the direction in which the image sequence can be changed. For those skillful in the art, it will be obvious that alternative indicators can be used to signal to the users the ability to navigate through a sequence of stacked images. 503 is an interactive single stacked bar chart-like component showing the voting results for a two-item decision-making question. 503 is divided into three areas, 504A, 504B, and 504C, representing the proportion of votes for each distinct choice. 504A shows the proportion of negative votes for both items, i.e., for the question “A or B”, 504A represents the number of explicit votes for “Neither”. 504B represents the positive votes for the current item displayed in view within the stacked image container 501. 504C is grayed out to indicate that the representative item is not currently displayed in view within the stacked image container 501. The proportionate areas 504B and 504C are action buttons, allowing the user to switch the displayed item by tapping or clicking on the corresponding area. 504A is not an action button, and, thus gestures and events cannot trigger change of the displayed image in the stacked image container 501.

FIG. 5B shows the same interactive display 500 of a multi-item decision-making question as shown on FIG. 5A, but it also shows the display changes when the user switches the view to the next item 510 in the sequence. Since there are only two items in the sequence in this example, the side bar is now displayed on the left side indicating that the user has to swipe to the right in order to change the displayed item. The visual effects on the interactive single stacked bar chart-like component 511 have also changed but the sequence of the stacked areas within the bar 511 remains the same. The first area 512A represents the proportion of the negative votes for both items. The second area 512B represents the proportion of positive votes for the first item in the sequence and is grayed out to indicate that the image of the corresponding item is not currently displayed in view. Area 512C shows the proportion of positive votes for the second item in the sequence which is currently displayed. Areas 512B and 512C are action buttons allowing users to interactively change the displayed image currently in view.

FIG. 6A shows the ordered interactive stacked bar chart-like component 600A for a three item decision-making question. Areas 601A, 602A, 603A, and 604A represent the distinct decision choices and are arranged in accordance with the ordered sequence of the items in the stacked image container described in the prior paragraphs. Area 601A represents the proportion of “No” votes for all three items. Areas 602A, 603A, and 604A are color coded distinctly and represent the proportion of positive votes for each item in the image sequence. Area 603A has a highlighted border indicating that the corresponding image is currently being displayed in view.

FIG. 6B shows a different state of the ordered interactive stacked bar chart-like component 600B from that of shown in FIG. 6A. The proportions of all areas 601B, 602B, 603B, and 604B have changed as a result of the real-time collection and aggregation of votes. As the new votes come in, some proportions may change visibly as those of 603B and 604B, while others may remain the same as 601B and 602B. The real-time collection and aggregation of votes can produce various proportionate distributions in the ordered stacked bar. The border of area 604B is highlighted to indicate that the image of the corresponding item is currently being displayed in view.

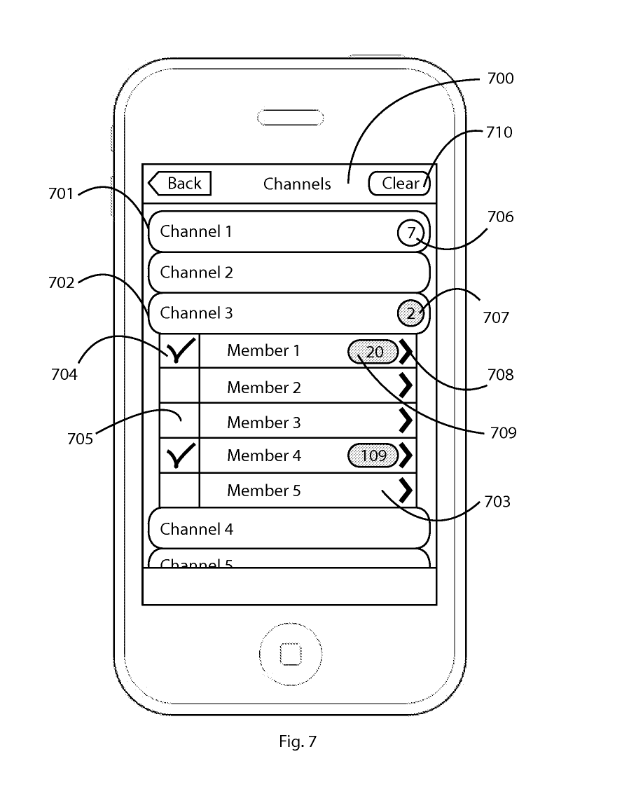

FIG. 7 shows the channel subscription and management screen 700 of the present invention. Users can subscribe to receive new contents and feedback to their decision-making questions from the experts and organizations they are interested in. Experts and organizations in similar fields are grouped into channels such as 701 and 702. Channel 702 is expanded to display its members as shown by the example member 703. 704 is a checked input control indicating that the user has subscribed to this particular channel member. 705 is an unchecked input control indicating that the user has not subscribed to this channel member. Channel 701 is collapsed, and, thus, its members are not visible. Yet, indicator 706 shows that the user has subscribed to seven members in channel 701. Indicator 707 for channel 702 is highlighted to show that there are unseen posts from some of the user's subscribed members. 709 is an indicator showing how many people have provided feedback on this member post. 708 is an action indicator that a tap or a mouse click will take the user to this member information and his or her posts. 710 is an action button that allows the user to clear all subscriptions from the currently expanded channel.

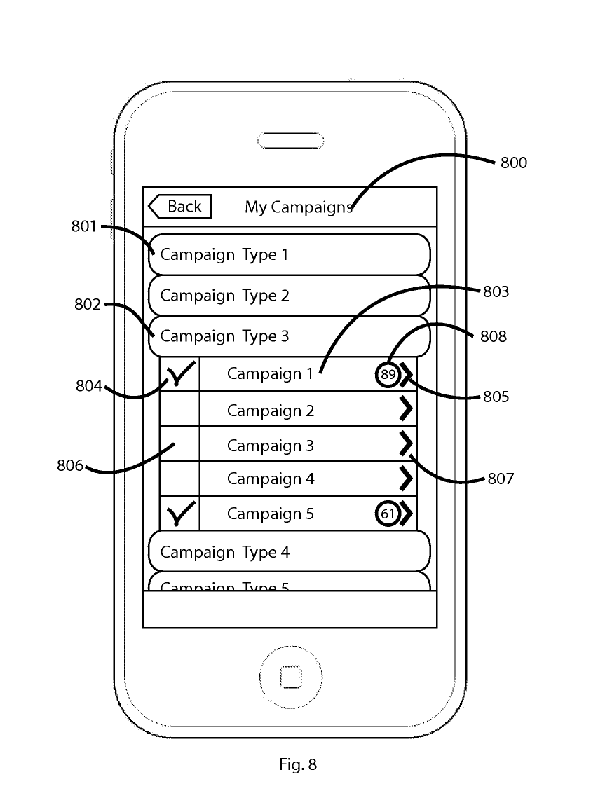

FIG. 8 shows the social media campaign management module 800 of the present invention that allows channel members, experts, and other users to push recommendations proactively to their social friends and measure their interest in the recommended items. Campaigns are organized by types into collapsible navigation components as in 801 and 802. 801 is collapsed, and, thus, the individual campaigns are not visible. 802 is expanded and displaying different campaigns as in 803 and 807. 804 is an automatically generated checkmark indicator showing that campaign 803 has been executed. Another indicator, 808, shows the total number of responses to campaign 803. 805 indicates that the campaign 803 label can be tapped or clicked to open the module to display the results described in prior paragraphs. Campaign 807 is created by an administrator or the user but has not been executed yet as indicated by the lack of a checkmark in the checkmark indicator 806.

What is claimed is:

1) Computer based method for a real-time personal social shopping decision support via electronic devices comprising:
Creating an ad hoc decision-making question;
Submitting a posting for the said ad hoc decision-making question to select social networks and messaging systems;
Collecting and tabulating social feedback to the said ad hoc decision-making question;
Algorithmically appending targeted commercial content to the said posting;
Collecting and tabulating social feedback to the said commercial content;
Iteratively modifying the said commercial content in the said posting based on the said social feedback;
Enlisting subject matter experts to provide feedback on the said posting.

2) The method of claim 1, further comprising the step of:
Attaching descriptive images to the said ad hoc decision-making question.

3) The method of claim 1, further comprising the step of:
Programmatically generating content-specific voting controls for the said decision-making question.

4) The method of claim 1, further comprising the step of:
Programmatically generating voting controls for the said commercial content in the said posting.

5) The method of claim 1, wherein the tabulated social feedback is posted to all participating members in the social shopping decision support.

6) The method of claim 1, wherein the iterative modification of the said commercial content comprises a commercial bidding.

7) The method of claim 1, wherein the electronic device is a smart phone, tablet, or a computer.

8) An instant picture-polling method comprising:
Producing an image with an electronic device;
Generating a single-question polling form from the said image on the said electronic device;
Programmatically instantiating voting controls;
Simultaneously posting the said single-question polling form to multiple social media networks from the said electronic device;
Collecting, tabulating, and displaying the social voting results on the said electronic device.

9) The method of claim 8, further comprising the step of:
Adding images to an options sequence.

10) The method of claim 8, wherein the said voting controls are algorithmically construed by the number of images included in the said single-question polling form plus one rejection option.

11) The method of claim 8, wherein the social voting results display comprises a view-stack image navigation container bi-directionally coordinated with an interactive frequency stacked bar.

12) The method of claim 8, wherein the electronic device is a smart phone, tablet or a computer.

13) A method for a digital interactive display of voting results on pictorial polling questions comprising:
An event-sensitive navigation container for displaying a stacked image sequence;
An interactive stacked bar for displaying the voting frequencies for each image in the said stacked image sequence;
An event-sensitive action trigger defined for each stack of the said interactive stacked bar for changing the displayed image in the said event-sensitive navigation container;
An event-sensitive action trigger defined for each displayed image in the said event-sensitive navigation container for setting visual emphasis on the corresponding stack in the said interactive stacked bar.

14) The method of claim 13, wherein the event-sensitive controls are operated via gestures, taps, or mouse clicks.

15) A personal ad hoc social picture-polling and decision support system comprising:
A function to instantiate impromptu a single-question polling template on an electronic device;
A function to capture and add choice images to the said single-question polling template;
A function to add descriptive text to the said decision-making polling template;
A function to automatically generate a distributable social media posting from the said single-question polling template;
A function to automatically construe all voting options from the said choice images and append corresponding voting controls to the said distributable social media posting;
A function to add free form text input control to the said distributable social media posting;
A function to post the said distributable social media posting to one or more social media and messaging systems simultaneously;
A function to collect, tabulate and display the voting results and other feedback on the said electronic device in real time.

16) The system of claim 15, wherein the said voting options are construed based on the number of choice images plus one rejection option.

17) The system of claim 15, wherein the incoming votes are tabulated and posted to the said social media and messaging systems.

18) The system of claim 15, further comprising a function to subscribe to picture-polls from particular users.

19) The system of claim 15, further comprising a function to engage in commercial bidding within the said posting.

20) The system of claim 15, further comprising a function to enlist experts to provide decision support.

21) The method of claim 15, wherein the electronic device is a smart phone, tablet or a computer.
